(19) United States
(12) Patent Application Publication
(10) Pub. No.: US 2014/0108740 A1
(43) Pub. Date: Apr. 17, 2014

(54) PREFETCH THROTTLING

(71) Applicant: ADVANCED MICRO DEVICES, INC., Sunnyvale, CA (US)

(72) Inventors: Todd Rafacz, Austin, TX (US); Marius Evers, Sunnyvale, CA (US); Chitresh Narasimhaiah, San Jose, CA (US)

(73) Assignee: Advanced Micro Devices, Inc., Sunnyvale, CA (US)

(21) Appl. No.: 13/653,951

(22) Filed: Oct. 17, 2012

(51) Int. Cl. G06F 12/08

(52) U.S. Cl. 711/137; 711/E12.057

(57) ABSTRACT

A processing system monitors memory bandwidth available to transfer data from memory to a cache. In addition, the processing system monitors a prefetching accuracy for prefetched data. If the amount of available memory bandwidth is low and the prefetching accuracy is also low, prefetching can be throttled by reducing the amount of data prefetched. The prefetching can be throttled by changing the frequency of prefetching, prefetching depth, prefetching confidence levels, and the like.

### FIELD OF THE DISCLOSURE

The present disclosure generally relates to processing systems and more particularly to prefetching for processing systems.

### BACKGROUND

Prefetching techniques often are employed in processing systems to speculatively fetch instructions and data from memory in anticipation of their use at later point. Typically, a prefetch operation involves initiating a memory access request to access the prefetch data (operand or instruction data) from memory and to store the accessed data in a corresponding cache array in the memory hierarchy. Prefetching typically uses the same infrastructure to access the memory as memory access requests generated by an executing program. Accordingly, prefetching operations often can impact processing efficiency.

### BRIEF DESCRIPTION OF THE DRAWINGS

The present disclosure may be better understood, and its numerous features and advantages made apparent to those skilled in the art by referencing the accompanying drawings.

FIG. 1 is a block diagram of a portion of a processing system including prefetch throttle control in accordance with some embodiments.

FIG. 2 is a block diagram of the prefetch throttle of FIG. 1 in accordance with some embodiments.

FIG. 3 is a flow diagram of a method of prefetching data at a processing system in accordance with some embodiments.

FIG. 4 is a flow diagram illustrating a method for designing and fabricating an integrated circuit device implementing a processing system in accordance with some embodiments.

The use of the same reference symbols in different drawings indicates similar or identical items.

### DETAILED DESCRIPTION

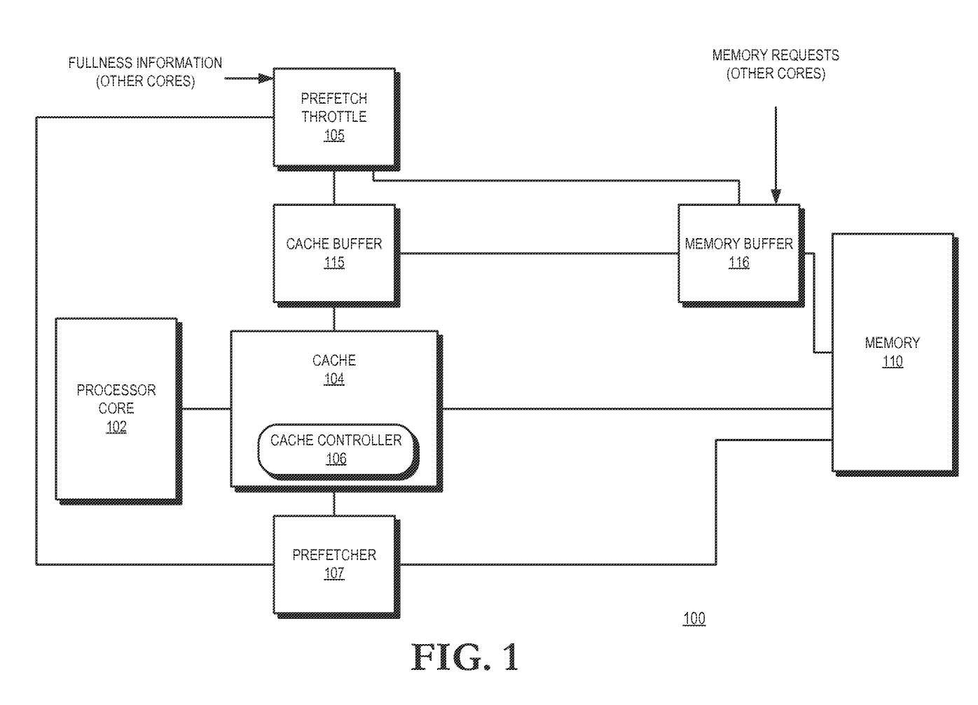

FIGS. 1-4 illustrate techniques to improve processing efficiency by throttling the prefetching of data to a cache based both on available memory bandwidth and on prefetching accuracy. In some embodiments, as prefetching operations impact the available bandwidth of a memory, a processing system monitors the available memory bandwidth and a prefetching accuracy of a prefetcher and throttles the prefetcher accordingly. The processing system determines the prefetch accuracy by determining, relative to the total amount of (prefetched data that is stored in the cache, how much prefetched data is retrieved from the cache. As such, a relatively inaccurate prefetcher may be throttled while memory bandwidth is at a premium, thus freeing memory bandwidth for higher-priority accesses, while also being permitted to prefetch at a greater frequency when there is relatively abundant available memory bandwidth as the impact of inaccurate prefetching is lower at such times.

As used herein, “prefetching accuracy” refers to the amount of data prefetched to a cache that is subsequently accessed at the cache prior being evicted from the cache relative to the total amount of data prefetched to the cache. That is, prefetch accuracy indicates the percentage of the prefetched data that is actually used by executing instructions at the processing system. In some embodiments, the prefetching accuracy for prefetching process is determined based on a cache hit metric, such as the number of prefetched cache lines accessed from the cache before being evicted compared to the total number of cache lines prefetched over a given duration. For example, if fourteen cache lines are prefetched by a processing system, and ten of those cache lines are accessed at the cache before they are evicted, the prefetch accuracy can be said to be 71.4%. “Throttling prefetching” and “prefetch throttling,” as used herein, refer to one of or a combination of changing a rate at which data is prefetched by, for example, changing a rate at of prefetch accesses to memory, by changing the amount of data that is prefetched for each prefetch access, and the like.

Memory bandwidth can be indicated by the total amount of data that can be transferred between memory and the cache or other processing system modules in a given amount of time. That is, memory bandwidth can be expressed in an amount of data per unit of time, such as 10 gigabytes per second (GB/s). The memory bandwidth depends on a number of features of a processing system, including the number of memory channels, the width of the buses that access the memory, the size of memory and cache buffers, the clock speed that governs transfers to and from memory, and the like. The available memory bandwidth refers to the portion of memory bandwidth that is not being used to transfer data at a given time (that is, the unused portion of the memory bandwidth at any given time). To illustrate, if the memory bandwidth of the processing system is 10 GB/s, and data is currently being transferred to and from the memory at 4 GB per second, there is 6 GB/s of available bandwidth. That is, the processing system has the capacity to transfer an addition 6 GB/s to/from memory. Memory bandwidth is consumed both by memory access requests generated by executing programs and by prefetching data from the memory based on the generated memory access requests. Accordingly, by throttling prefetching when available memory bandwidth and prefetching accuracy are both low, available memory bandwidth can be more usefully made available to an executing program, thereby enhancing processing system efficiency.

FIG. 1 illustrates a block diagram of a processing system 100 that throttles prefetching based on both available memory bandwidth and prefetch accuracy. The processing system 100 can be a part of any of a variety of electronic devices, such as a personal computer, server, personal or hand-held electronic device, telephone, and the like. The processing system 100 is generally configured to execute sets of instructions, referred to as software, in order to carry out tasks designated by the computer programs. The execution of sets of instructions by the processing system 100 primarily involves the storage, retrieval, and manipulation of data. Accordingly, the processing system 100 includes a memory 110 to store data and one or more processor cores (e.g. processor core 102) to retrieve and manipulate data. The processor core 102 can include, for example, a central processing unit (CPU) core, a graphics processing unit (GPU) core, or a combination thereof. The memory 110 can be volatile memory, such as random access memory (RAM), non-volatile memory, such as flash memory, a disk drive, or any combination thereof. In some embodiments, the processor core 102 and memory 110 are incorporated in separate semiconductor dies.

The processor core 102 includes one or more instruction pipelines that perform the operations of determining the set of instructions to be executed and executing those instructions by causing instruction data, operand data, and other such data to be retrieved from the memory 110, manipulating that data according to the instructions, and causing the resulting data to be stored at the memory 110. It will be appreciated that although a single processor core 102 is illustrated, the processing system 100 includes additional processor cores. Further, the processor core 102 can be a multithreaded core, whereby the instructions to be executed at the core are divided into threads, with the processor core 102 able to execute each thread independently. Each thread can be associated with a different computer program or different defined computer program function. The processor core 102 can switch between executing threads in response to defined conditions in order to increase processing efficiency.

The processing system 100 further includes a cache 104. For ease of illustration, the processing system 100 is illustrated with a single cache, but in other implementations the processing system 100 may implement a multi-level cache hierarchy (e.g., a level 1 cache, a level 2 cache, etc.). The cache 104 is configured to store data in sets of storage locations referred to as cache lines, whereby each cache line stores multiple bytes of data. The cache 104 includes, or is connected to, a cache tag array (not shown) and includes a cache controller 106 that receives a memory address associated with a load/store operation (the toad/store address). The cache controller 106 reviews the data stored at the cache 104 to determine if it stores the data associated with the load/store address (the load/store data). If so, a cache hit is indicated, and the cache controller 106 completes the load/store operation at the cache 104. In the case of a store operation, the cache 104 modifies the cache line associated with a store address based on corresponding store data. In the case of a load operation, the cache 104 retrieves the load data at the cache line associated with the load address and provides it to the entity, such as the processor core 102, which generated the load request.

If the cache controller 106 determines that the cache 104 does not store the load/store data, a cache miss is indicated. In response, the cache controller 106 sends a request to the memory 110 to access the load/store data. In response, the memory 110 retrieves the load/store data based on the load/store address and provides it to the cache 104. The load/store data is therefore available at the cache 104 for subsequent load/store operations. In some embodiments, the memory 110 provides data to the cache 104 at the granularity of a cache line, which may differ from the granularity of load/store data identified by a load/store address. To illustrate, a load/store address can identify load/store data at a granularity of 4-bytes and each cache line of the cache 104 can store 64 bytes. Accordingly, in response to a request for load/store data, the memory 110 provides a 64-byte segment of data that includes the 4-byte segment of data indicated by the load/store address.

In response to receiving load/store data from the memory 110, the cache controller 106 determines if it has a cache line available to store the data. A cache line is determined to be available if it is not identified as storing valid data associated with a memory address. If no cache line is available, the cache controller 106 selects a cache line for eviction. To evict a cache line, the cache controller 106 determines if the data stored at the cache line has been modified by a store operation. If not, cache controller 106 replaces the data at the cache line with the load/store data provided by the memory 110. If the data stored at the cache line has been modified, the cache controller 106 retrieves the stored data and provides it to the memory 110 for storage. The cache controller 106 thus ensures that any changes to the data at the cache 104 are reflected at the corresponding data stored at the memory 110.

As explained above, data is transferred between the cache 104 and the memory 110 in response to cache misses, cache line evictions, and the like. To facilitate the efficient transfer of data and enhance memory bandwidth, the cache 104 and the memory 110 each includes buffers, illustrated as cache buffer 115 and memory buffer 116, respectively. The cache buffer 115 temporarily stores data that is either awaiting transfer to the memory buffer 116 or awaiting storage at the cache 104. The memory buffer 116 stores data responsive to memory access requests from all the processor cores of the processing system 100, including the processor core 102. The memory buffer 116 therefore allows the memory 110 to provide data to and receive data from the processor cores asynchronously relative to the corresponding processor core's operations. To illustrate, in response to a cache miss at a cache associated with a processor core, the memory 110 provides data to the cache for storage. The data can be temporarily stored in the memory buffer 116 until the cache buffer of the corresponding cache is ready to store it. Once the cache buffer signals it is ready, the memory buffer 116 provides the temporarily stored data to the cache buffer.

In the event that the memory buffer 116 is full, it indicates to the cache buffers for the processor cores, including cache buffer 115, that transfers are to be suspended. Once space becomes available at the memory buffer 116, transfers can be resumed. As explained above, the available memory bandwidth indicates the rate of data that can be transferred between memory and a cache in a defined amount of time. Accordingly, if the memory buffer 116 is full, no data can be transferred between the caches of the processor core 102 and the memory 110, indicating an available memory bandwidth of zero. In contrast, if the memory buffer 116 and all of the cache buffers for all of the processor cores of the processing system 100 are empty, the available memory bandwidth with respect to the cache 104 is at a maximum value. The fullness of the cache buffers for the processor cores, including the cache buffer 115, and the fullness of the memory buffer 116 thus provide an indication of the available memory bandwidth. In some embodiments, there is a linear relationship between the fullness of the buffers and the available memory bandwidth, such that the buffer fullness of the fullest of the buffers is proportionally representative of the current available memory bandwidth. In this case, the buffer that is fuller limits the available memory bandwidth. Thus, for example, if the cache buffer 115 is 55% full, the other cache buffers of the processing system 100 are less than 55% full and the memory buffer 116 is 25% full, then the fullest of the buffers is 55% and thus the available memory bandwidth is estimated as 45% (100%−55%). In some embodiments, there may be a non-linear relationship between the fullness of the cache buffers, the memory buffer 116, and the available memory bandwidth. In some mbodiments, the available memory bandwidth can be based on a combination of the fullness of each of the cache buffers and the memory buffer 116, such as an average fullness of the buffers. In some embodiments, the available memory bandwidth can be based on the utilization of a memory bus or any other resource that is used to complete a memory access. As explained further below, the available memory bandwidth can be used to determine whether to throttle prefetching of data to the cache 104.

The prefetcher 107 is configured to be selectively placed in either an enabled state or in a suspended state in response to received control signaling. In the enabled state, the prefetcher 107 is configured to speculatively prefetch data to the cache 104 based on access patterns, for example, branch prediction information (for instruction data prefetches) or based on, for example, stride pattern analysis (for operand data prefetching). Based on the access patterns, the prefetcher 107 initiates a memory access to transfer additional data from the memory 110 to the cache 104. To illustrate, the prefetcher 107 may determine that an explicit request for data associated with a given memory address (Address A) is frequently followed closely by an explicit request for data associated with a different memory address (Address B). This access pattern indicates that the program executing at the processor core 102 would execute more efficiently if the data associated with Address B were transferred to the cache 104 in response to an explicit request for the data associated with Address A. Accordingly, in response to detecting an explicit request to transfer the data associated with Address A, the prefetcher 107 will prefetch the data associated with Address B by causing the Address B data to be transferred to the cache 104.

The amount of additional data requested for a particular prefetch operation is referred to as the “prefetch depth.” In some embodiments, the prefetch depth is an adjustable amount that the prefetcher 107 can set based on a number of variables, including the access patterns it identifies, user-programmable or operating system-programmable configuration information, a power mode of the processing system 100, and the like. As explained further below, the prefetch depth can also be adjusted as part of a prefetch throttling process in view of available memory bandwidth.

In the suspended state, the prefetcher 107 does not prefetch data. In some embodiments, the suspended state the prefetcher 107 corresponds to a retention state, whereby it does not perform active operations, but retains the state of information at the prefetcher 107 immediately prior to entering the retention state. In the retention state the prefetcher 107 consumes less power than when it is in its enabled state.

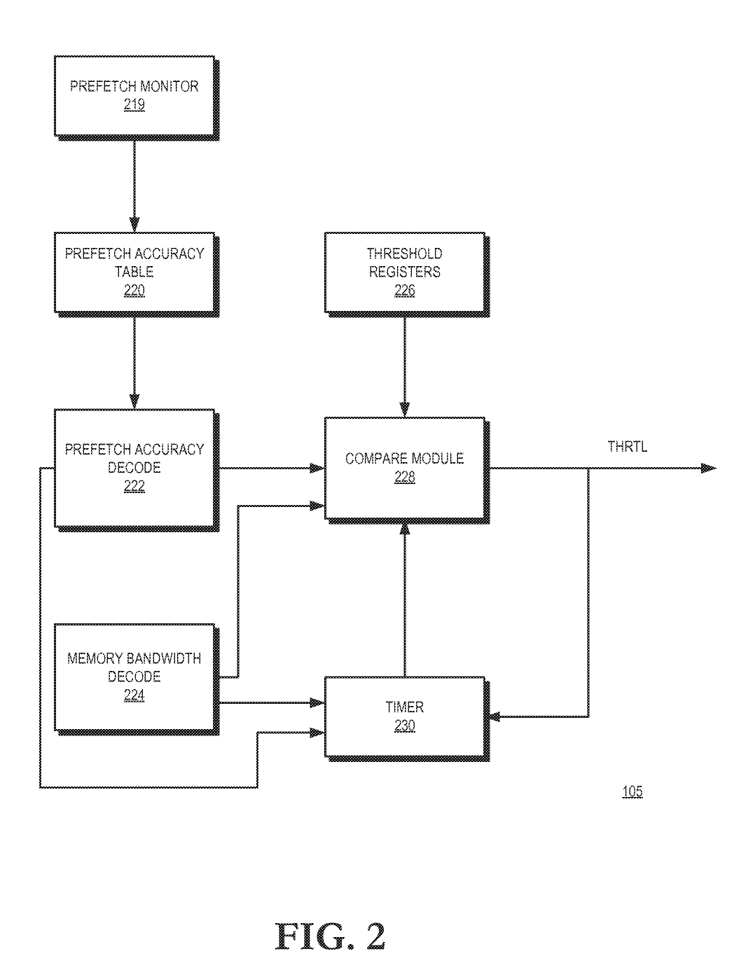

The processing system 100 includes a prefetch throttle 105 that controls the rate at which the prefetcher 107 prefetches data based on the available memory bandwidth and the prefetch accuracy. The prefetch throttle 105 determines the prefetch accuracy by maintaining a data structure (e.g. FIG. 2, prefetch accuracy table 220) that indicates which data stored at the cache 104 is the result of a prefetch, and whether that prefetched data has been accessed from the cache (that is, has been the target of a load/store operation) at the cache 104. In some embodiments, the data structure is in the form of a pair of bits for each cache line of the cache 104. One of the bits in the pair indicates whether the corresponding cache line data resulted from a prefetch and the other bit in the pair indicates whether the data has been accessed at the cache 104. Based on this data structure, the prefetch throttle 105 is able to determine the prefetch accuracy based on the prefetched data at the cache 104. In some embodiments, the prefetch throttle 105 maintains a table that indicates a particular subset (less than all) of the prefetched data stored at the cache 104, and whether that data has been accessed by the processor core 102. In some embodiments the prefetch accuracy is estimated by the prefetcher 107 based on other information such as confidence information stored at the prefetcher 107.

In some embodiments the prefetch throttle 105 maintains a table whereby each entry of the table stores the memory address associated with a prefetched cache line and an access bit to indicate whether a cache line associated with the memory address was accessed. When the processor core 102 accesses a line in the cache 104, it can check whether the memory address associated with the cache line is stored at the table. If the address is stored in the table, the processor core 102 sets the access bit of the corresponding table entry. The state of the access bits therefore collectively indicate the ratio of accessed prefetch lines to non-accessed prefetch lines. The ratio can be used by the prefetcher 105 as a measure of the prefetch accuracy.

In some embodiments, the prefetch throttle 105 determines the available memory bandwidth by determining the fullness of buffers 115 and 116 and the fullness of the cache buffers for other processor cores of the processing system 100. The prefetch throttle 105 compares the available memory bandwidth and the prefetch accuracy to corresponding threshold amounts and, based on the comparison, sends control signaling to the prefetcher 107 to throttle prefetching. To illustrate, the following table sets out example available memory bandwidth thresholds and corresponding prefetch efficiency thresholds:

| Available Memory | Prefetch Efficiency | Prefetch Throttle |
|---|---|---|
| Bandwidth Threshold | Threshold | Time |
| 25% | 35% | 15 cycles |
| 15% | 55% | 18 cycles |
| 30% | 58% | 25 cycles |
| 5% | 60% | 40 cycles |

Accordingly, based on the above table, if the prefetch throttle 105 determines that the available memory bandwidth is less than 25% and the prefetch efficiency is less than 35%, it throttles prefetching. Similarly, if the prefetch throttle determines that the available memory bandwidth is less than 15% and the prefetch efficiency is less than 55%, it throttles prefetching.

It will be appreciated that some embodiments the prefetch throttle 105 can throttle prefetching based on other threshold or comparison schemes. For example, in some embodiments the corresponding thresholds for the available memory bandwidth and the prefetch efficiency can be defined by continuous, rather than discrete values. In some embodiments, the prefetch throttle 105 can employ fuzzy logic to determine whether to throttle prefetching. For example, the prefetch throttle 105 can make a particular decision as to whether to throttle prefetching based on comparing the prefetch accuracy to multiple prefetch thresholds and comparing the available memory bandwidth to multiple available memory bandwidth thresholds.

In some embodiments, the prefetch throttle 105 throttles prefetching by suspending prefetching for a defined period of time, where the defined period of period of time can be defined based on a number of clock cycles or can be defined based on a number of events, such as a number of prefetches that were suppressed due to throttling of the prefetcher 107. Upon expiration of the defined period, the prefetch throttle 105 sends control signaling to the prefetcher 107 to resume prefetching. If, after resumption of prefetching, the prefetch throttle 105 determines that the available memory bandwidth is still below the threshold corresponding to the measured prefetch accuracy, the prefetch throttle can send control signaling to again suspend prefetching for the defined length of time. The amount of time that the prefetch throttle 105 throttles prefetching can vary depending on the available memory bandwidth and based on the prefetch efficiency. For example, as set forth in the table above, in one example the prefetch throttle 105 can suspend prefetching for 15 cycles in response to determining that the available memory bandwidth is less than 25% and the prefetch efficiency is less than 35%, and can suspend prefetching for 25 cycles in response to determining that the available memory bandwidth and the prefetch efficiency are each less than 30%.

In some embodiments, the prefetch throttle 105 throttles prefetching by changing the prefetch depth for a defined period of time. To illustrate, in response to determining that the available memory bandwidth is below the threshold corresponding to the measured prefetch accuracy, the prefetch throttle 105 sends control signaling to the prefetcher 107 to reduce the prefetch depth, and thus retrieve less data for each prefetch, for a defined period of time. After expiration of the defined period, the prefetch throttle 105 can send control signaling to the prefetcher 107 to resume prefetching with a greater prefetch depth.

In some embodiments, the prefetch throttle 105 throttles prefetching by changing other prefetch parameters, such as confidence thresholds of the prefetcher 107. Thus, for example, the prefetcher 107 can determine whether to issue a memory access based on a confidence level that an access pattern has been detected. The prefetch throttle 105 can throttle prefetching by increasing the confidence threshold that triggers issuance of a memory access by the prefetcher 107, thereby reducing the number of memory accesses issued by the prefetcher 107.

FIG. 2 illustrates a block diagram of the prefetch throttle 105 in accordance with some embodiments. The prefetch throttle 105 includes a prefetch monitor 219, a prefetch accuracy table 220, a prefetch accuracy decode module 222, a memory bandwidth decode module 224, threshold registers 226, a compare module 228, and a timer 230. The prefetch accuracy table 220 stores data indicating the amount of data at the cache 104 that has been prefetched (in terms of number of cache lines, for example) and the amount of the prefetched data that has been accessed at the cache 104 (also in terms of number of cache lines, for example). The prefetch monitor 219 monitors the prefetcher 107 and the cache 104 to determine when data has been prefetched to the cache 104, and also monitors the cache 104 to determine when prefetched data has been evicted from the cache 104. Based on this information, the prefetch monitor 219 updates the prefetch accuracy table 220 to reflect the amount of prefetched data, in cache lines, stored at the cache 104. The prefetch monitor 219 also monitors the cache 104 to determine when prefetched data stored at the cache 104 causes a cache hit, indicating that the prefetched data has been accessed. Based on this information, the prefetch monitor 219 updates the prefetch accuracy table to reflect the amount of prefetched data, in cache lines, that has been accessed at the cache 104.

The prefetch accuracy decode module 222 generates a value (the prefetch accuracy value) indicative of the prefetch accuracy based on the data at the prefetch accuracy table 220. In some embodiments, the prefetch accuracy decode module 222 generates the prefetch accuracy value by performing a division of the number of cache lines at the cache 104 that store prefetched data and have triggered a cache hit, as indicated by the prefetch accuracy table 220, by the total number of cache lines at the cache 104 that store prefetched data. The prefetch accuracy value will thus indicate a percentage of prefetched data that has been accessed at the cache 104.

The memory bandwidth decode module 224 generates a value (the available memory bandwidth value) indicative of the amount of memory bandwidth available between the cache 104 and the memory 110. In some embodiments, the memory bandwidth decode module receives information from the buffers 115 and 116 and the cache buffers for other processor cores of the processing system 100 indicating the relative fullness of each buffer, and generates the available memory bandwidth value based on the buffer fullness.

The threshold registers 226 store values indicating available memory bandwidth thresholds and corresponding prefetch accuracy thresholds. The compare module 228 compares the available memory bandwidth value generated by the memory bandwidth decode module 224 to the available memory bandwidth thresholds. In addition, the compare module 228 compares the prefetch accuracy value generated by the prefetch accuracy decode module 222 to the prefetch accuracy thresholds. Based on these comparisons, the compare module 228 generates control signaling, labeled “THRTL”, for provision to the prefetcher 107 indicating whether prefetching is suspended.

The timer 230 includes a counter to count from an initial value to a final value in response to the THRTL signaling indicating that prefetching is suspended. In response to the counter reaching the final value, the timer 230 sends a reset indication to the compare module 228, which sets the THRTL signaling to resume prefetching. In some embodiments, the timer 230 sets the initial value of the counter based on the available memory bandwidth value, the prefetch accuracy value, and their corresponding thresholds.

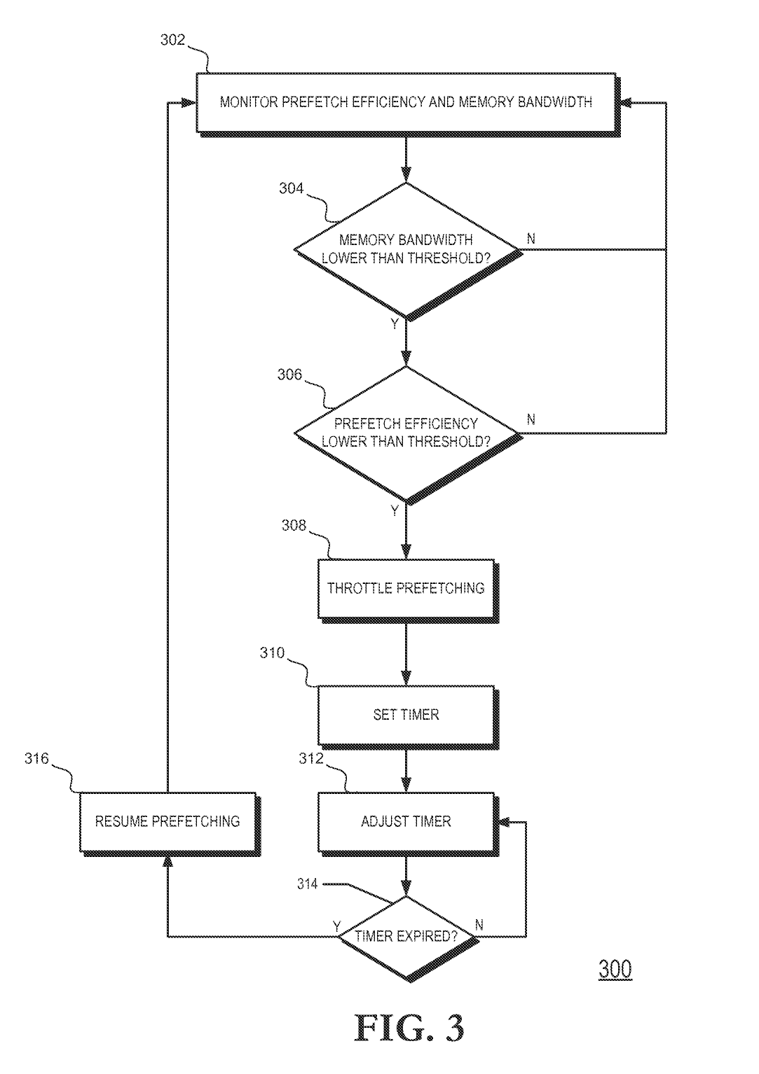

FIG. 3 illustrates a method 300 of prefetch throttling at a processing system in accordance with some embodiments. For ease of illustration, the method 300 is described in the example context of the processing system 100 of FIGS. 1 and 2. At block 302, the prefetch throttle 105 monitors the prefetch accuracy of the prefetcher 107 and the available memory bandwidth between the cache 104 and the memory 110. As part of the monitoring process, the prefetch throttle 105 updates the prefetch accuracy table 220 (FIG. 2) responsive to cache accesses. At block 304 the memory bandwidth decode module 224 generates the available memory bandwidth value based on the collective fullness of the cache buffers of the processing system 100, such as cache buffer 115 and the fullness of the memory buffer 116. The compare module 228 compares the available memory bandwidth value to the available memory bandwidth thresholds stored at the threshold registers 226. If the available memory bandwidth value is greater than the available memory bandwidth thresholds, prefetching is not throttled. Accordingly, the method flow returns to block 302.

At block 304, in response to the compare module 228 determining that the available memory bandwidth value is less than one of the available memory bandwidth thresholds, the compare module determines the lowest available memory bandwidth threshold that is greater than the available memory bandwidth value. For purposes of discussion, this available memory bandwidth threshold is referred to as the available memory bandwidth threshold of interest. The compare module 228 identifies the prefetch accuracy threshold, stored at the threshold registers 226, that is paired with the available memory bandwidth threshold of interest. The identified prefetch accuracy threshold is referred to as the prefetch accuracy threshold of interest. The method flow proceeds to block 306.

At block 306, the prefetch accuracy decode module 222 decodes the prefetch accuracy table to generate the prefetch accuracy value. The compare module 228 compares the prefetch accuracy value to the prefetch accuracy threshold of interest. If the prefetch accuracy value is greater than the prefetch accuracy threshold of interest, prefetching is not be throttled. Therefore, the method flow returns to block 302. If the prefetch accuracy value is greater than the prefetch accuracy threshold of interest the method flow proceeds to block 308. At block 308 the compare module 228 sets the state of the THRTL control signaling so that the prefetcher 107 suspends prefetching.

The method flow proceeds to block 310 and the timer 230 sets the initial value of its counter to the value indicated by the available memory bandwidth threshold of interest and its paired prefetch accuracy threshold of interest. At block 312 the timer 230 adjusts the counter. At block 314 the timer 230 determines if the counter has reached the final value. If not, the method flow returns to block 312. If the counter has reached the final value, the method flow moves to block 314 and the compare module 228 sets the state of the THRTL control signaling so that the prefetcher 107 resumes prefetching. The method flow returns to block 302 and the prefetch throttle 105 continues monitoring the prefetch accuracy and the available memory bandwidth.

In some embodiments, the apparatus and techniques described above are implemented in a system comprising one or more integrated circuit (IC) devices (also referred to as integrated circuit packages or microchips), such as the processing system described above with reference to FIGS. 1-3. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

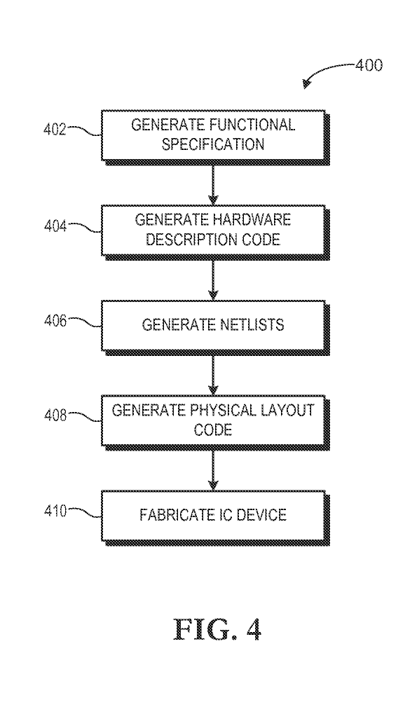

FIG. 4 is a flow diagram illustrating an example method 400 for the design and fabrication of an IC device implementing one or more aspects disclosed above. As noted above, the code generated for each of the following processes is stored or otherwise embodied in computer readable storage media for access and use by the corresponding design tool or fabrication tool.

At block 402 a functional specification for the IC device is generated. The functional specification (often referred to as a micro architecture specification (MAS)) may be represented by any of a variety of programming languages or modeling languages, including C, C++, SystemC, Simulink, or MATLAB.

At block 404, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 406 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 408, one or more EDA tools use the netlists produced at block 406 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 410, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions that, when executed by the one or more processors, manipulate the one or more processors to perform one or more aspects of the techniques described above. The software is stored or otherwise tangibly embodied on a computer readable storage medium accessible to the processing system, and can include the instructions and certain data utilized during the execution of the instructions to perform the corresponding aspects.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the disclosed embodiments as set forth in the claims below. Accordingly, the specification and figures are to be regarded in an illustrative rather than a restrictive sense, and all such modifications are intended to be included within the scope of the disclosed embodiments.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method, comprising:
throttling prefetching of data from a memory to a cache based on an available memory bandwidth of the memory and based on a prefetch accuracy of the prefetching.

2. The method of claim 1, wherein throttling prefetching of data comprises:
throttling prefetching of data for a first period of time in response to the available memory bandwidth being less than a first threshold and the prefetch accuracy being less than a second threshold.

3. The method of claim 2, wherein throttling prefetching of data comprises:
throttling prefetching of data by for a second period of time in response to the available memory bandwidth being less than a third threshold and the prefetch accuracy being less than a fourth threshold.

4. The method of claim 1, wherein throttling prefetching of data comprises:
setting a prefetch depth to a first depth in response to the available memory bandwidth being less than a first threshold and the prefetch accuracy being less than a second threshold, the prefetch depth indicating an amount of data prefetched.

5. The method of claim 4, wherein throttling prefetching of data comprises:
setting the prefetch depth to a second depth in response to the available memory bandwidth being less than a third threshold and the prefetch accuracy being less than a fourth threshold.

6. The method of claim 1, further comprising:
determining the prefetch accuracy by monitoring a cache hit rate for a subset of cache lines prefetched to the cache.

7. The method of claim 6, further comprising:
determining the prefetch accuracy by monitoring a cache hit rate for all cache lines prefetched to the cache.

8. The method of claim 1, further comprising:
estimating the available memory bandwidth by monitoring the fullness of at least one of: a cache buffer that buffers data provided to and from the cache and a memory buffer that buffers data provided to and from the memory.

9. The method of claim 8, wherein estimating the available memory bandwidth comprises estimating the available memory bandwidth based on both the fullness of the cache buffer and the fullness of the memory buffer.

10. A method, comprising:
prefetching data from a memory; and
temporarily suspending the prefetching in response to determining that a prefetch accuracy is below a first threshold and that an available memory bandwidth of the memory is less than a second threshold.

11. The method of claim 10, wherein temporarily suspending the prefetching comprises temporarily suspending the prefetch for a first period of time, and the method further comprises:
temporarily suspending the prefetching for a second period of time in response to determining that the prefetch accuracy is below a third threshold.

12. The method of claim 10, wherein temporarily suspending the prefetching comprises temporarily suspending the prefetch for a first period of time, and the method further comprises:
temporarily suspending the prefetching for a second period of time in response to determining that the available memory bandwidth is below a third threshold.

13. A processing system, comprising:
a cache;
a prefetcher coupled to the cache, the prefetcher to prefetch data from a memory to the cache based on control signaling; and
a prefetch throttle coupled to the cache, the prefetch throttle to set the control signaling based on a prefetch accuracy of the prefetcher and based on an available memory bandwidth of the memory.

14. The processing system of claim 13, wherein the prefetch throttle sets the control signaling to suspend prefetching for a first period of time in response to determining the available memory bandwidth is less than a first threshold and the prefetch accuracy being less than a second threshold.

15. The processing system of claim 14, wherein the prefetch throttle sets the control signaling to suspend prefetching for a second period of time in response to the available memory bandwidth being less than a third threshold and the prefetch accuracy being less than the second threshold.

16. The processing system of claim 13, wherein the prefetch throttle sets the control signaling to set a prefetch depth to a first depth in response to the available memory bandwidth being less than a first threshold and the prefetch accuracy being less than a second threshold.

17. The processing system of claim 16, wherein the prefetch throttle sets the control signaling to set the prefetch depth to a second depth in response to the available memory bandwidth being less than a third threshold and the prefetch accuracy being less than the second threshold.

18. The processing system of claim 13 wherein the prefetch throttle determines the prefetch accuracy by monitoring a cache hit rate for a subset of cache lines prefetched to the cache.

19. The processing system of claim 13 wherein the prefetch throttle is to determine the prefetch accuracy by monitoring a cache hit rate for all cache lines prefetched to the cache.

20. The processing system of claim 13, further comprising:
a first buffer coupled to the cache; and
wherein the prefetch throttle is to determine the available memory bandwidth by monitoring the fullness of the first buffer.

21. The processing system of claim 20, further comprising:
a second buffer coupled to the memory; and
wherein the prefetch throttle is to determine the available memory bandwidth by monitoring the fullness of the second buffer.

22. The processing system of claim 21, wherein the second buffer is to receive data from the first buffer.

23. A computer readable medium storing code to adapt at least one computer system to perform a portion of a process to fabricate at least part of a processing system comprising:
a cache;
a prefetcher coupled to the cache, the prefetcher to prefetch data from a memory to the cache based on control signaling; and
a prefetch throttle coupled to the cache, the prefetch throttle to set the control signaling based on a prefetch accuracy of the prefetcher and based on an available memory bandwidth of the memory.

24. The computer readable medium of claim 23, wherein the prefetch throttle sets the control signaling to suspend prefetching for a first length of time in response to determining the available memory bandwidth is less than a first threshold and the prefetch accuracy being less than a second threshold.

25. The computer readable medium of claim 24, wherein the prefetch throttle sets the control signaling to suspend prefetching for a second length of time in response to the available memory bandwidth being less than a third threshold and the prefetch accuracy being less than the second threshold.
